(19) United States
(12) Patent Application Publication
(10) Pub. No.: US 2008/0093282 A1
(43) Pub. Date: Apr. 24, 2008

(54) Water treatment system

(76) Inventor: Masayuki Ukon, Saitama (JP)

Correspondence Address: WENDEROTH, LIND & PONACK, L.L.P., 2033 K STREET N. W., SUITE 800, WASHINGTON, DC, 20006-1021, US

(21) Appl. No.: 11/907,694

(22) Filed: Oct. 16, 2007

(30) Foreign Application Priority Data
Oct. 19, 2006 (JP) JP2006-285454

(51) Int. Cl. C02F 1/44

(52) U.S. Cl. 210/192; 210/321.6

(57) ABSTRACT

In a water treatment system with a function of filtering raw water, a filter can be securely and efficiently sterilized without using dangerous chemicals such as hydrochloric acid and sulfuric acid. The water treatment system 1 has a strongly acidic aqueous solution generating unit 17 provided with an electrolytic bath for storing a solution containing an electrolyte, the electrolytic bath having a cathode chamber and an anode chamber which are partitioned by an ion-permeable membrane, a cathode and an anode disposed in the cathode chamber and the anode chamber, respectively, and a voltage applying section for applying a direct current voltage between the cathode and the anode; a strongly acidic aqueous solution feeding passage 18 for connecting the strongly acidic aqueous solution generating unit 17 to a raw water inlet of a reverse osmosis membrane module 2 housing a reverse osmosis membrane to supply a strongly acidic aqueous solution generated in the strongly acidic aqueous solution generating unit 17 into the reverse osmosis membrane module 2; and potentiometers V1 and V5 for measuring a oxidation-reduction potential of the strongly acidic aqueous solution which has passed through the reverse osmosis membrane module 2.

### BACKGROUND OF THE INVENTION

1. Field of the Invention

The present invention relates to a water treatment system having a function for filtering various kinds of water such as seawater or river water.

2. Description of the Related Art

Techniques conventionally employed for seawater desalination, which belongs to water treatment technologies, are exemplified as a reverse osmosis method using a reverse osmosis membrane, a freeze concentration method for crystallizing water as ice, and an electrodialysis method to separate ions in a solution by an electric potential difference using a membrane having a fixed electric charge. Among these methods, the reverse osmosis method is widely known as the most efficient method for seawater desalination because the method, in particular, consumes the least energy. In a water treatment system using the reverse osmosis method, a reverse osmosis membrane module is provided, in which raw water is fed with pressure into the reverse osmosis membrane module to be subjected to reverse osmosis, thereby generating permeated water and concentrated water.

In this method, however, if the pH of raw water fed into the reverse osmosis membrane module is high, or pH 6 or above, for example, components contained in the raw water such as calcium, sodium, magnesium or the like precipitate as scale, which sometimes causes deterioration of the filtering efficiency of the reverse osmosis membrane. To solve the problem, the pH of raw water in the reverse osmosis membrane module is maintained to be low during the treatment by adding acid such as hydrochloric acid or sulfuric acid to the raw water before being fed into the reverse osmosis membrane module. In this method, after the water passes through the reverse osmosis membrane module, a strongly alkaline reducing agent such as caustic soda is added to the water to return the pH to the original value.

When hydrochloric acid or the like is added to raw water in order to inhibit scaling, a reverse osmosis membrane made of a cellulose triacetate material, which has an excellent acid resistance, is used. However, a membrane of a cellulose triacetate material is erosive to bacteria existing in raw water. Since the bacteria cannot be eliminated only by lowering the pH of raw water by adding strong acid, these bacteria will grow on the surface of the reverse osmosis membrane to deteriorate the function of the membrane. Therefore, in order to inhibit the growth of bacteria, the reverse osmosis membrane module is constantly or regularly sterilized with chlorine-based chemicals such as hydrochloric acid or hypochlorous acid (see Unexamined Japanese Patent Publication No. 2000-042544, for example).

In the treatment method described in Unexamined Japanese Patent Publication No. 2000-042544, dangerous chemicals such as hydrochloric acid or sulfuric acid are used. These chemicals should be transferred and stored under strict control in view of safety ensuring. In addition, a structure with a complicated device is required to add the chemicals and clean the components, which makes its control system more complicated too, leading to difficulties in handling the device.

In order to solve the above problems, a method for cleaning a filtering device and a reverse osmosis membrane without using acid such as hydrochloric acid or sulfuric acid has been suggested (see Unexamined Japanese Patent Publication No. 2003-103259, for example). The filtering device disclosed in Unexamined Japanese Patent Publication No. 2003-103259, while having a simple structure, sterilizes a reverse osmosis membrane and also removes scale by cleaning the membrane with a strongly acidic aqueous solution.

In the filtering device in Unexamined Japanese Patent Publication No. 2003-103259, a strongly acidic aqueous solution is fed into a reverse osmosis membrane module which houses a reverse osmosis membrane therein to sterilize the reverse osmosis membrane and to remove scale. In this device, however, after feeding the strongly acidic aqueous solution, it is difficult to confirm whether the sterilization has been completed or not. Therefore, the elimination is sometimes incomplete. In addition, the strongly acidic aqueous solution may continue to flow in even after the completion of sterilization, which wastes the solution.

An object of the present invention is to provide a water treatment system having a function of securely and efficiently sterilizing a filter without using dangerous chemicals such as hydrochloric acid or sulfuric acid.

### SUMMARY OF THE INVENTION

A water treatment system according to the present invention comprises a filter for filtering raw water; a strongly acidic aqueous solution generating unit provided with an electrolytic bath for storing a solution containing an electrolyte, the electrolytic bath having a cathode chamber and an anode chamber which are partitioned by an ion-permeable membrane, a cathode and an anode disposed in the cathode chamber and the anode chamber, respectively, and a voltage applying section for applying a direct current voltage between the cathode and the anode; a strongly acidic aqueous solution feeding passage for connecting the strongly acidic aqueous solution generating unit to a raw water inlet of the filter to supply a strongly acidic aqueous solution generated in the strongly acidic aqueous solution generating unit to the filter; and a potentiometer for measuring a oxidation-reduction potential of the strongly acidic aqueous solution after the solution has passed through the filter.

Here, a strongly acidic aqueous solution means, when water added with an electrolyte such as NaCl (or KCl) is electrolyzed, the solution generated on the side of an anode. The solution has the chemical property of pH 2.7 or less and an oxidation-reduction potential of +1,100 mV or more.

By the above structure, the strongly acidic aqueous solution with a bactericidal effect generated in the strongly acidic aqueous solution generating unit is supplied to the filter to sterilize the filter without using dangerous chemicals such as hydrochloric acid or sulfuric acid. Moreover, the oxidation-reduction potential of the strongly acidic aqueous solution which has passed through the filter is measured by the potentiometer to monitor the degree of reduction, thereby judging whether the strongly acidic aqueous solution is deteriorated by sterilization. Thus, it is possible to observe the progress of the sterilizing treatment. In other words, when the oxidation-reduction potential of the strongly acidic aqueous solution after passing through the filter is largely decreasing (less than 1100 mV, for example), the sterilization has not been completed. The oxidation-reduction potential of the strongly acidic aqueous solution which is equivalent to or more than the potential of the solution before feeding (1100 mV or more, for example) indicates completion of the sterilization. Accordingly, it is possible to prevent a feeding amount and treating time of the strongly acidic aqueous solution from becoming excessive or remaining deficient, and thus the filter can be securely and efficiently sterilized.

Here, the filter may be a reverse osmosis membrane which generates permeated water and concentrated water by filtering raw water. Permeated water is a solution from which ingredients contained therein have been eliminated by passing through a reverse osmosis membrane. Concentrated water is a solution with an increased concentration of its ingredients by removing permeated water from raw water.

By the above structure, in a water treatment system having a reverse osmosis membrane for seawater desalination, the strongly acidic aqueous solution generated in the strongly acidic aqueous solution generating unit is supplied to the reverse osmosis membrane so that the reverse osmosis membrane can be sterilized without using dangerous chemicals such as hydrochloric acid or sulfuric acid as in the system described above. Furthermore, by measuring the oxidation-reduction potential of the strongly acidic aqueous solution which has passed through the reverse osmosis membrane by the potentiometer, the progress of the sterilizing treatment can be monitored to judge whether the sterilization is completed. Therefore, both excess and deficiency in feeding amount and treating time can be prevented, thereby securely and efficiently sterilizing the reverse osmosis membrane.

Preferably, a discharging passage capable of taking out a strongly acidic aqueous solution generated in the strongly acidic aqueous solution generating unit may be further provided. By this structure, the strongly acidic aqueous solution can be taken out through the discharging passage according to need so that the strongly acidic aqueous solution can be utilized for other purposes than the sterilization of the reverse osmosis membrane, which improves convenience.

In the above structure, it is possible to provide a discharging passage capable of pouring out a solution generated by mixing the strongly acidic aqueous solution with the permeated water. By this structure, the strongly acidic aqueous solution can be diluted in an appropriate concentration according to an intended use, which enhances applicability.

### BRIEF DESCRIPTION OF THE DRAWINGS

In the accompanying drawings:

FIG. 1 is a schematic view showing a water treatment system of an embodiment of the present invention; and

FIG. 2 is a schematic view showing a strongly acidic aqueous solution generating unit which constitutes the water treatment system of FIG. 1.

### DETAILED DESCRIPTION OF THE PREFERRED EMBODIMENT

A preferred embodiment is explained below with reference to the accompanied drawings. The embodiment is, however, an example of the present invention, and the water treatment system of the present invention is not limited to this embodiment.

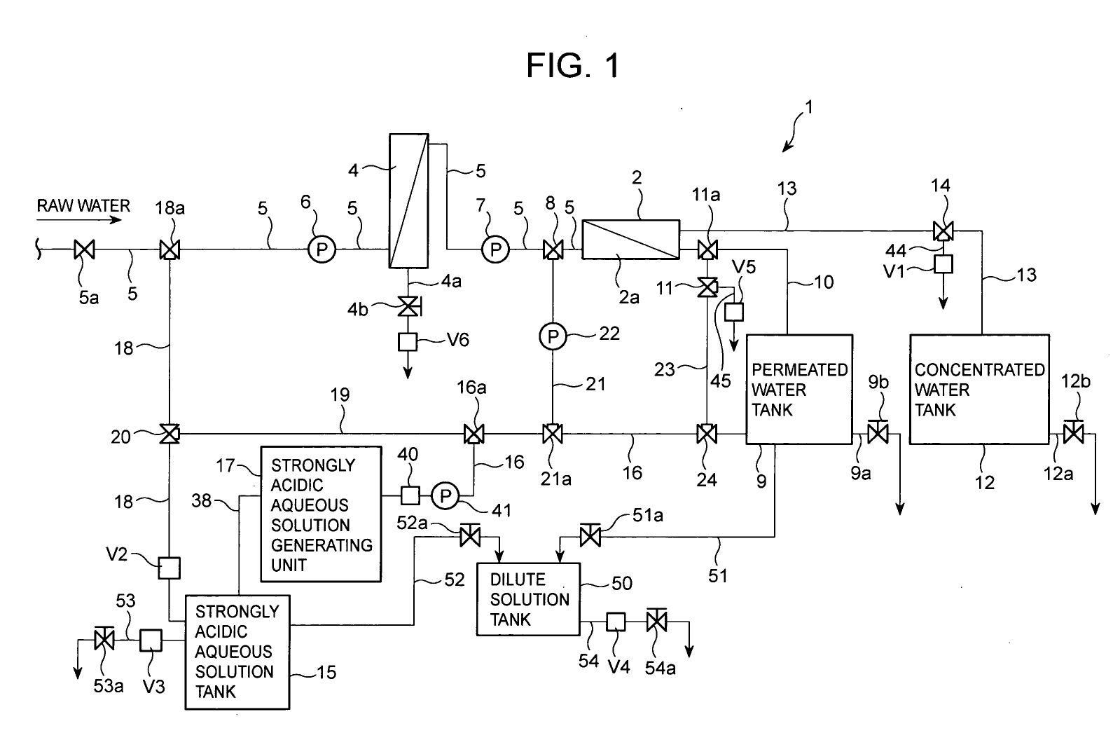

As shown in FIG. 1, a water treatment system 1 is provided with a reverse osmosis membrane module 2 as a filter, and a reverse osmosis membrane (not shown) is housed in a container body 2a of the reverse osmosis membrane module 2. The reverse osmosis membrane has a form of a hollow filament and a plurality of the membranes are stacked in a linear form or a U-shape and fixed by connecting with synthetic resin or the like at distal ends thereof. The reverse osmosis membrane used here is made of cellulose triacetate having acid resistance. The container body 2a has a sealed structure with an inlet and outlets (not shown) opened for feeding in raw water and for discharging permeated and concentrated water. To the inlet and outlets, a raw water passage, a permeated water passage, and a concentrated water passage, which are explained later, are connected, respectively. In the reverse osmosis membrane module 2, raw water is divided into permeated water which passes through the reverse osmosis membrane and concentrated water which does not pass through the reverse osmosis membrane.

The reference numeral 4 denotes a precision filter for removing particles or the like from raw water before feeding into the reverse osmosis membrane module 2. 4a denotes a discharging passage for the precision filter 4 for discharging the particles or the like removed by the precision filter 4, and 4b denotes a discharging switching valve disposed in the discharging passage 4a. Furthermore, on a downstream side of the discharging switching valve 4b in the discharging passage 4a, a potentiometer V6 is disposed. The precision filter 4 used in this embodiment is made of polyvinylidene fluoride which has high mechanical strength as well as excellent chemical resistance. Since a diameter of a pore of the precision filter 4 is approximately from 0.1 μm to 1.0 μm, particles contained in raw water having an outer diameter of 1.0 μm or more are discharged from the discharging passage 4a along with approximately 10% of the raw water. An amount of the raw water discharged with the particles from the discharging passage 4a can be optionally set by adjusting an opening degree of the discharging switching valve 4b.

The reference numerals 5 denotes a raw water passage which runs from a raw water supplying port (not shown) though a raw water supplying valve 5a and the precision filter 4 and then is connected to the reverse osmosis membrane module 2. 6 denotes a feed pump which is disposed on an upstream side of the precision filter 4 in the raw water passage 5 for feeding raw water. 7 denotes a high-pressure pump which is disposed on an upstream side of the reverse osmosis membrane module 2 in the raw water passage 5 for pressurizing raw water flowing into the reverse osmosis membrane module 2. By pressurizing raw water with the high-pressure pump 7, the raw water is divided into permeated water which has been subjected to reverse osmosis by the reverse osmosis membrane in the reverse osmosis membrane module 2 and concentrated water which has not been subjected to reverse osmosis. A ratio of a flow rate of the divided permeated water to a flow rate of the divided concentrated water is adjusted by flow rate adjusting valves which are provided on an outlet side of the permeated water and an outlet side of the concentrated water of the reverse osmosis membrane module 2. In this embodiment, the pressure loaded on raw water by the high-pressure pump 7 is set approximately at 6 MPa, and the ratio of the flow rate of the divided permeated water to the flow rate of the divided concentrated water is set at 4:6.

The reference numeral 8 denotes a downstream-side reverse flow cross valve which is disposed on an upstream side of the reverse osmosis membrane module 2 in the raw water passage 5. 9 denotes a permeated water tank for storing permeated water which has passed through the reverse osmosis membrane module 2. 9a denotes a permeated water feeding passage for feeding permeated water stored in the permeated water tank 9 to another system (not shown). 9b denotes a switching valve for feeding permeated water which is disposed in the permeated water feeding passage 9a. 10 denotes a permeated water passage for connecting the reverse osmosis membrane module 2 to the permeated water tank 9. 11 denotes a cross valve for discharging permeated water. Permeated water, which is discharged from the reverse osmosis membrane module 2 toward the permeated water passage 10, is discharged via a cross valve 11a for the permeated water passage (described next) from the cross valve 11. 11a denotes a cross valve for the permeated water passage, which switches the passage of the permeated water between a permeated water tank 9 side and a cross valve 11 side.

The reference numeral 12 denotes a concentrated water tank for storing concentrated water which has been concentrated by the reverse osmosis membrane module 2. 12a denotes a concentrated water feeding passage for feeding concentrated water stored in the concentrated water tank 12 to another system (not shown). 12b denotes a switching valve for feeding concentrated water which is disposed in the concentrated water feeding passage 12a. 13 denotes a concentrated water passage for connecting the reverse osmosis membrane module 2 to the concentrated water tank 12. 14 denotes a cross valve for discharging concentrated water which is disposed in the concentrated water passage 13. 15 denotes a strongly acidic aqueous solution tank for storing a strongly acidic aqueous solution. In addition, a strongly acidic aqueous solution discharging passage 53 and a switching valve 53a are provided so that the strongly acidic aqueous solution in the strongly acidic aqueous solution tank 15 can be taken out according to need, and a potentiometer V3 is disposed for measuring an oxidation-reduction potential of the strongly acidic aqueous solution passing through the strongly acidic aqueous solution discharging passage 53.

The reference numeral 16 denotes a permeated water supplying passage, of which one end is connected to the permeated water tank 9 and the other end connected to a strongly acidic aqueous solution generating unit 17 explained later. The permeated water supplying passage 16 supplies the permeated water stored in the permeated water tank 9 to the strongly acidic aqueous solution generating unit 17. 16a denotes a supplying passage cross valve which is disposed in the permeated water supplying passage 16 and to which a bypass passage 19 explained later is connected. 17 denotes a strongly acidic aqueous solution generating unit for generating and supplying a strongly acidic aqueous solution to the strongly acidic aqueous solution tank 15.

The reference numeral 18 denotes a strongly acidic aqueous solution feeding passage, of which one end is connected to a feeding cross valve 18a disposed in the raw water passage 5 and communicates with the precision filter 4 and the reverse osmosis membrane module 2 via the raw water passage 5, and the other end connected to the strongly acidic aqueous solution tank 15. The strongly acidic aqueous solution tank 15 communicates with the strongly acidic aqueous solution generating unit 17 via an anode water passage 38. The strongly acidic aqueous solution stored in the strongly acidic aqueous solution tank 15 is fed from the strongly acidic aqueous solution feeding passage 18 to the reverse osmosis membrane module 2 via the feeding cross valve 18a through the raw water passage 5. In the strongly acidic aqueous solution feeding passage 18, a potentiometer V2 is disposed for measuring an oxidation-reduction potential of the strongly acidic aqueous solution passing therethrough.

The reference numeral 19 denotes a bypass passage for bypassing the permeated water supplying passage 16 and the strongly acidic aqueous solution feeding passage 18. 20 denotes a bypass cross valve disposed in the strongly acidic aqueous solution feeding passage 18, to which the bypass passage 19 is connected. 21 denotes a reverse flow bypass passage which connects the downstream-side reverse flow cross valve 8 to the permeated water supplying passage 16. 21a denotes an upstream-side reverse flow cross valve disposed in the permeated water supplying passage 16, to which the reverse flow bypass passage 21 is connected. 22 denotes a reverse flow pump disposed in the reverse flow bypass passage 21, and 23 is a bypass passage for circulation which connects the permeated water passage 10 and the permeated water supplying passage 16. 24 denotes a cross valve for circulation disposed in the permeated water supplying passage 16, to which the circulating bypass passage 23 is connected.

In a discharging passage 44 which communicates with the cross valve 14 for discharging concentrated water, a potentiometer V1 is disposed for measuring an oxidation-reduction potential of the strongly acidic aqueous solution discharged therethrough. A permeated water flow-in passage 51 and a switching valve 51a are provided for feeding the permeated water in the permeated water tank 9 into a dilute solution tank 50. A strongly acidic aqueous solution flow-in passage 52 and a switching valve 52a are provided for feeding the strongly acidic aqueous solution in the strongly acidic aqueous solution tank 15 to the dilute solution tank 50. Furthermore, a discharging passage 54 and a switching valve 54a are provided for pouring out the solution (which is a solution of the strongly acidic aqueous solution diluted by the permeated water) stored in the dilute solution tank 50 according to need. A potentiometer V4 is disposed in the discharging passage 54 for measuring an oxidation-reduction potential of the solution passing therethrough.

An operation of filtering process of raw water in the water treatment system 1 of the present embodiment is described below. Examples of raw water used here are seawater to be desalinated, river water or tap water to be purified. In this embodiment, seawater is used as raw water, and an example of dividing seawater into pure water as permeated water and concentrated water is explained.

By opening the raw water supplying valve 5a, raw water is supplied to the raw water passage 5 from the raw water supplying port (not shown). The raw water supplied to the raw water passage 5 is fed to the precision filter 4 by the feed pump 6 to remove particles such as dust, sand and soil contained in the raw water and microorganisms which are larger than a pore of the precision filter 4. The removed particles or the like are discharged from the discharging passage 4a of the precision filter 4 along with approximately 10% of raw water fed into the precision filter 4. The raw water passing through the precision filter 4 is fed with pressure to the reverse osmosis membrane module 2 by the high-pressure pump 7. In the reverse osmosis membrane module 2, saline matters, calcium, magnesium, and the like contained in the raw water are removed, and permeated water which has passed through the reverse osmosis membrane in the reverse osmosis membrane module 2 flows into the permeated water tank 9 via the permeated water passage 10 and is stored therein.

At the same time, the saline matters, calcium, magnesium, and the like which have been separated from fresh water with the reverse osmosis membrane of the reverse osmosis membrane module 2 are, as concentrated water with approximately 60% of raw water fed into the reverse osmosis membrane module 2, stored in the concentrated water tank 12 via the concentrated water passage 13. Here, the permeated water and the concentrated water passing through the permeated water passage 10 and the concentrated water passage 13, respectively, may not necessarily be stored in each tank. It can be possible that the permeated water is discharged from the cross valve 11 for discharging permeated water via the cross valve 11a for the permeated water passage and that the concentrated water is discharged from the cross valve 14 for discharging concentrated water. This is a filtering process of raw water using the reverse osmosis membrane module 2.

As described above, as the filtering process of raw water with the reverse osmosis membrane module 2 continues, the function of the reverse osmosis membrane is deteriorated because of propagation of bacteria and accumulation of inorganic salts. If the deterioration further progresses, some problems occur. Namely, a pressure difference between the raw water flow-in side and the permeated water discharging side becomes excessively large, or the flow rate of the permeated water passing through the reverse osmosis membrane module 2 is decreased. Therefore, the reverse osmosis membrane module 2 is subjected to sterilization and cleaning of scale using strongly acidic aqueous solution. The strongly acidic aqueous solution used for sterilization and cleaning of scale is the solution generated in the strongly acidic aqueous solution generating unit 17.

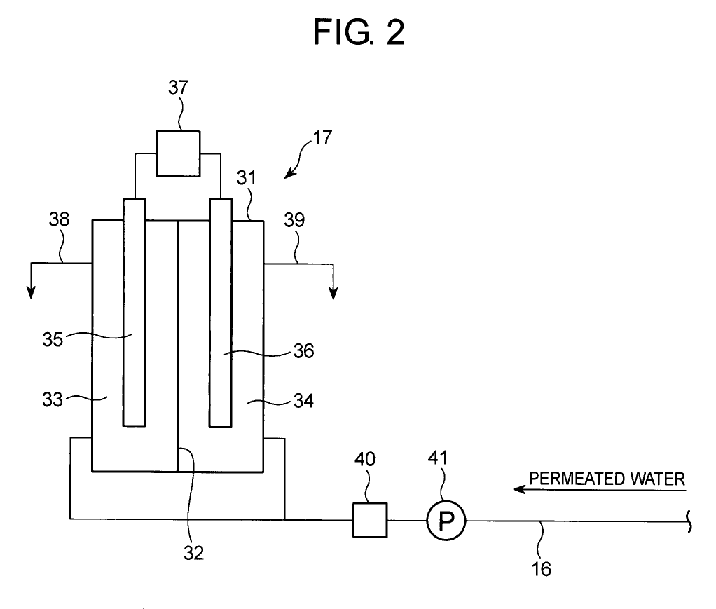

Next, a process of producing strongly acidic aqueous solution is explained with reference to FIG. 2.

In FIG. 2, the reference numeral 31 denotes an electrolytic bath; 32 denotes an ion-permeable membrane for partitioning an inside of the electrolytic bath 31; 33 denotes an anode chamber formed by partitioning the electrolytic bath 31 with the ion-permeable membrane 32; 34 denotes a cathode chamber formed by partitioning the electrolytic bath 31 with the ion-permeable membrane 32; 35 denotes an anode disposed in the anode chamber 33; 36 denotes a cathode disposed in the cathode chamber 34; and 37 denotes a voltage applying section for applying a direct current voltage to the anode 35 and the cathode 36.

To the anode chamber 33, an anode water passage 38 is connected so that anode water (strongly acidic aqueous solution) generated in the anode chamber 33 is supplied to the strongly acidic aqueous solution tank 15 (see FIG. 1). A cathode water passage 39 is provided for discharging cathode water (strongly alkaline electrolyte solution) generated in the cathode chamber 34. The reference numeral 40 denotes an electrolyte adding section for adding electrolytes to permeated water to produce an electrolyte solution. The reference numeral 41 denotes a permeated water supplying pump for supplying permeated water from the permeated water supplying passage 16 to the electrolytic bath 31.

In a process producing strongly acidic aqueous solution, firstly, the supplying passage cross valve 16a, the upstream-side reverse flow cross valve 21a, and the circulating cross valve 24, all shown in FIG. 1, are switched, thereby opening a passage through which permeated water is supplied from the permeated water tank 9 via the permeated water supplying passage 16 to the strongly acidic aqueous solution generating unit 17. Then, the permeated water supplying pump 41 is activated to supply the permeated water stored in the permeated water tank 9 shown in FIG. 2 to the electrolytic bath 31 of the strongly acidic aqueous solution generating unit 17. Here, the electrolyte adding section 40 adds a predetermined amount of electrolyte to the permeated water to produce an electrolyte solution. The electrolyte used in this embodiment is sodium chloride.

In the electrolytic bath 31 to which the solution added with electrolyte has been supplied, the voltage applying section 37 applies direct current voltage between the cathode 36 and the anode 35. Then, the electrolyte solution is electrolyzed to generate a strongly acidic aqueous solution as anode water in the anode chamber 33. The strongly acidic aqueous solution thus generated is stored in the strongly acidic aqueous solution tank 15 shown in FIG. 1 via the anode water passage 38. At the same time, a strongly alkaline electrolyte solution as cathode water is generated in the cathode chamber 34 and discharged from the cathode water passage 39.

The strongly acidic aqueous solution generated in the strongly acidic aqueous solution generating process is set to be approximately pH 1.8 to 3.5, or preferably, pH 2.0 to 2.7, with an ORP (oxidation-reduction potential) of 1000 mV or more, or preferably, 1100 mV or more. Therefore, the solution has a strong bactericidal effect. This strongly acidic aqueous solution fed into the reverse osmosis membrane module 2 can powerfully sterilize the reverse osmosis membrane in the reverse osmosis membrane module 2. Moreover, the strongly acidic aqueous solution generated as above shows a low pH value, which inhibits calcium in raw water from precipitating as calcium sulfate or the like. In addition, with the action of hydrogen ions in the strongly acidic aqueous solution, calcium matters in raw water can be dissolved and removed before accumulating on the reverse osmosis membrane in a form of calcium sulfate or the like.

Next, a sterilization and cleaning treatment of the reverse osmosis membrane module 2 is explained below. Firstly, the cross valve 14 for discharging concentrated water, which serves as a discharging port for the strongly acidic aqueous solution that has passed through the reverse osmosis membrane module 2, is switched from the reverse osmosis membrane module 2 to the direction of the discharging passage 44. Next, the feeding cross valve 18a is switched so that the strongly acidic aqueous solution feeding passage 18 communicates with the feed pump 6 of the raw water passage 5. Then, by activating the feed pump 6, the strongly acidic aqueous solution stored in the strongly acidic aqueous solution tank 15 is fed from the strongly acidic aqueous solution feeding passage 18 to the raw water passage 5 through the feeding cross valve 18a and further fed into the reverse osmosis membrane module 2 via the feed pump 6, the precision filter 4, the high-pressure pump 7 and the downstream-side reverse flow cross valve 8.

In this process, by applying a pressure of approximately 0.5 MPa to the passing strongly acidic aqueous solution, the solution is subjected to the reverse osmosis with the reverse osmosis membrane in the reverse osmosis membrane module 2 so that an inside of the reverse osmosis membrane, which is formed in a hollow filament, can be sterilized and scale can be cleaned off. When the strongly acidic aqueous solution permeates the inside of the reverse osmosis membrane, the cross valve 11a for the permeated water passage is switched to a side of the cross valve 11 for discharging permeated water so that the strongly acidic aqueous solution can be discharged from the reverse osmosis membrane module 2 through the cross valve 11 for discharging permeated water.

Right after the feed pump 6 is activated, the cross valve 14 for discharging concentrated water and the cross valve 11 for discharging permeated water are left open for a predetermined time so that raw water remaining within the raw water passage 5 and the reverse osmosis membrane module 2 is discharged. At the time when the inside of the reverse osmosis membrane module 2 has been filled with the strongly acidic aqueous solution after the predetermined time, the cross valve 14 for discharging concentrated water and the cross valve 11 for discharging permeated water are closed, and the feed pump 6 and the high-pressure pump 7 are stopped, thereby retaining the strongly acidic aqueous solution in the reverse osmosis membrane module 2 (a step of retaining the strongly acidic aqueous solution). In this step, the strongly acidic aqueous solution is retained for a predetermined time, or for sixty minutes in the present embodiment.

After the strongly acidic aqueous solution is retained in the reverse osmosis membrane module 2 in the above step, the solution in the reverse osmosis membrane module 2 is discharged from the cross valve 14 for discharging concentrated water. Upon discharging, the supplying passage cross valve 16a is switched so that the permeated water supplying passage 16 communicates with the bypass passage 19, and the bypass cross valve 20 is switched so that the bypass passage 19 further communicates with the strongly acidic aqueous solution feeding passage 18 which is connected to the raw water passage 5.

Then, by activating the feed pump 6, the permeated water in the permeated water tank 9 is fed through the permeated water supplying passage 16, the supplying passage cross valve 16a, the bypass passage 19, the bypass cross valve 20, the strongly acidic aqueous solution feeding passage 18, and the feeding cross valve 18a to the raw water passage 5, and is fed into the reverse osmosis membrane module 2 via the feed pump 6, the precision filter 4, and the high-pressure pump 7. The strongly acidic aqueous solution in the line of the water treatment system 1 and in the reverse osmosis membrane module 2 is discharged from the discharging passage 44 via the concentrated water passage 13 and the cross valve 14 for discharging concentrated water.

Here, by measuring an oxidation-reduction potential of the discharged strongly acidic aqueous solution with the potentiometer V1 disposed in the discharging passage 44, the condition of deterioration can be monitored. Specifically, if the oxidation-reduction potential of the strongly acidic aqueous solution that has passed through the inside of the reverse osmosis membrane module 2 is lower than the oxidation-reduction potential of the strongly acidic aqueous solution before feeding measured by the potentiometer V2 (less than 1100 mV, for example), it can be judged that sterilization has not been completed. If the potential of the discharged solution is equivalent to or higher than the potential before feeding (1100 mV or more, for example), it means that the sterilizing process has been finished. Therefore, it is possible to prevent a feeding amount and treating time of the strongly acidic aqueous solution from becoming excessive or remaining deficient, and thus the reverse osmosis membrane can be securely and efficiently sterilized.

On the other hand, the feed pump 6 may be continued to be operated after the inside of the reverse osmosis membrane module 2 is filled with the strongly acidic aqueous solution. In this case, the sterilizing treatment can be carried out by continuously discharging the strongly acidic aqueous solution that has passed through the reverse osmosis membrane module 2 from the discharging passage 44 of the cross valve 14 for discharging concentrated water and a discharging passage 45 of the cross valve 11 for discharging permeated water. Here, as described above, an oxidation-reduction potential of the strongly acidic aqueous solution discharged through the discharging passages 44 and 45 is measured with the potentiometers V1 and V5, respectively, in order to judge whether the sterilizing process has been completed or not. Therefore, as in the above case, it is possible to prevent a feeding amount and treating time of the strongly acidic aqueous solution from becoming excessive or remaining deficient, and thus the reverse osmosis membrane can be securely and efficiently sterilized.

After the step of discharging the strongly acidic aqueous solution, the reverse osmosis membrane of the reverse osmosis membrane module 2 can be cleaned by flushing or the like with the permeated water stored in the permeated water tank 9 (a cleaning step). The cleaning step can continuously follow the step of discharging the strongly acidic aqueous solution using the same passages as the passages of the permeated water used in the step of discharging the strongly acidic aqueous solution. In the cleaning step, the precision filter 4 can also be cleaned with the reverse flow. However, the reverse osmosis membrane module 2 cannot be cleaned with the reverse flow due to the property inherent in a reverse osmosis membrane.

When the precise filter 4 is cleaned by the reverse flow, the upstream-side reverse flow cross valve 21a is switched so that the permeated water supplying passage 16 on a side of the permeated water tank 9 communicates with the reverse flow bypass passage 21. Then, the downstream-side reverse flow cross valve 8 is switched so that the reverse flow bypass passage 21 communicates with the raw water passage 5 on a side of the precision filter 4. By activating the reverse flow pump 22, the permeated water in the permeated water tank 21 is fed into the precision filter 4 via the permeated water supplying passage 16, the upstream-side reverse flow cross valve 21a, the reverse flow bypass passage 21, the reverse flow pump 22, the downstream-side reverse flow cross valve 8, and the high-pressure pump 7. The permeated water flows back in the precision filter 4 and is discharged from the discharging passage 4a of the precision filter 4.

During the above process, since the high-pressure pump 7 is not in operation, the permeated water can pass through the high-pressure pump 7 without any resistance. It is also possible that, after opening a passage from the strongly acidic aqueous solution tank 15 via the reverse flow bypass passage 21 to the precision filter 4, by activating the reverse flow pump 22, the strongly acidic aqueous solution stored in the strongly acidic aqueous solution tank 15 is fed in the precision filter 4 and discharged from the discharging passage 4a of the precision filter 4, thereby cleaning the precision filter 4 with the reverse flow of the strongly acidic aqueous solution. At this time, an oxidation-reduction potential of the strongly aqueous solution discharged from the discharging passage 4a for the precision filter 4 is measured by the potentiometer V6 to judge whether the sterilization has been completed.

Following the step of feeding the strongly acidic aqueous solution into the reverse osmosis membrane module 2, the strongly acidic aqueous solution can be circulated to the reverse osmosis membrane module 2. In this strongly acidic aqueous solution circulating step, the downstream-side reverse flow cross valve 8, the cross valve 11a for the permeated water passage, the cross valve 11 for discharging permeated water, the cross valve 24 for circulation, and the upstream-side reverse flow cross valve 21a are switched so as to form a circulating passage running from the reverse osmosis membrane module 2, via the bypass passage 23 for circulation, the permeated water supplying passage 16, and the reverse flow bypass passage 21, to the reverse osmosis membrane module 2 again. The strongly acidic aqueous solution is circulated in this passage by activating the reverse flow pump 22 (the step of circulating the strongly acidic aqueous solution).

In the above step, the strongly acidic aqueous solution is circulated to the reverse osmosis membrane module 2, enabling sterilization of the reverse osmosis membrane and removal of calcium matters in a short time. In this case, in the reverse flow pump 22, a predetermined pressure is applied to the circulating strongly acidic aqueous solution to feed the solution to the reverse osmosis membrane module 2 with the pressure. The strongly acidic aqueous solution which has passed through the reverse osmosis membrane of the reverse osmosis membrane module 2 flows to a side of the permeated water passage 10. At this time, the cross valve 14 for discharging concentrated water is closed so as not to pass the strongly acidic aqueous solution in the reverse osmosis membrane module 2 to a side of the concentrated water passage 13. While the circulating passage is formed on the side of the permeated water passage 10 in the present embodiment, it is also possible to form a circulating passage on the side of the concentrated water passage 13 to circulate the strongly acidic aqueous solution to the reverse osmosis membrane module 2 through this passage.

In this embodiment, the feed pump 6 is employed for feeding the strongly acidic aqueous solution into the reverse osmosis membrane module 2. However, instead of the feed pump 6, it is also possible to provide an injection pump or the like on the strongly acidic aqueous solution feeding passage 18 to feed the strongly acidic aqueous solution into the reverse osmosis membrane module 2 with the injection pump.

As shown in FIG. 1, the water treatment system 1 is further provided with a strongly acidic aqueous solution discharging passage 53 through which the strongly acidic aqueous solution generated in the strongly acidic aqueous solution generating unit 17 and stored in the strongly acidic aqueous solution tank 15 can be taken out. Accordingly, by opening the switching valve 53a according to need, the strongly acidic aqueous solution can be taken out from the strongly acidic aqueous solution discharging passage 53, and the oxidation-reduction potential of the taken out solution can be measured with the potentiometer V3. Thus, the strongly acidic aqueous solution generated in the strongly acidic aqueous solution generating unit 17 can be used for other purposes than the sterilization of the reverse osmosis membrane as described above, which improves convenience.

Furthermore, the water treatment system 1 is provided with the dilute solution tank 50 for storing a solution generated by mixing the strongly acidic aqueous solution in the strongly acidic aqueous solution tank 15 and the permeated water in the permeated water tank 9. The solution in the dilute solution tank 50 can be taken out through the discharging passage 54 by opening the switching valve 54a. Therefore, it is possible to use a strongly acidic aqueous solution which is diluted in appropriate concentration according to an intended use, which enhances applicability. Here, an oxidation-reduction potential of the solution taken out from the discharging passage 54 can be measured with the potentiometer V4 to confirm whether the oxidation-reduction potential is suitable for the intended use.

The water treatment system 1 according to this embodiment has the reverse osmosis membrane module 2 for seawater desalination. However, the present invention is not limited to the embodiment and is widely applicable to other water treatment systems provided with various kinds of filters having other functions than that of the reverse osmosis membrane module 2 to obtain the same operation and effect as those described above. In addition, since the water treatment system 1 does not require chemicals (dangerous chemicals such as hydrochloric acid or sulfuric acid) for sterilizing the reverse osmosis membrane module 2 and the precision filter 4, it is possible to use the water treatment system 1 on ships as a seawater desalination system.

The discharging switching valve 4b, the raw water supplying valve 5a, the downstream-side reverse flow cross valve 8, the switching valve 9b for feeding permeated water, the cross valve 11 for discharging permeated water, the cross valve 11a for the permeated water passage, the switching valve 12b for feeding concentrated water, the cross valve 14 for discharging concentrated water, the supplying passage cross valve 16a, the feeding cross valve 18a, the bypass cross valve 20, the upstream-side reverse flow cross valve 21a, the cross valve 24 for circulation, and the switching valves 51a and 52a can be made to be motor valves (not shown), and pressure sensors (not shown) can be provided in the raw water passage 5 between the feed pump 6 and the precision filter 4, in the raw water passage 5 between the high-pressure pump 7 and the reverse osmosis membrane module 2, and in the concentrated water passage 13 between the reverse osmosis membrane module 2 and the cross valve 14 for discharging concentrated water. Then, by providing control devices and control software to control switching of the motor valves and to control ON/OFF of the feed pump 6, the high-pressure pump 7, and the permeated water supplying pump 41 based on signals sent from the pressure sensors and the potentiometers V1 to V5, the water treatment system 1 can be automatically operated.

While there has been described what is at present considered to be a preferred embodiment of the invention, it will be understood that various modifications may be made thereto, and it is intended that the appended claims cover all such modifications as fall within the true spirit and scope of the invention.

What is claimed is:

1. A water treatment system comprising:
a filter for filtering raw water;
a strongly acidic aqueous solution generating unit provided with an electrolytic bath for storing a solution containing an electrolyte, the electrolytic bath having a cathode chamber and an anode chamber which are partitioned by an ion-permeable membrane, a cathode and an anode disposed in the cathode chamber and the anode chamber, respectively, and a voltage applying section for applying a direct current voltage between the cathode and the anode;
a strongly acidic aqueous solution feeding passage for connecting the strongly acidic aqueous solution generating unit to a raw water inlet of the filter to supply a strongly acidic aqueous solution generated in the strongly acidic aqueous solution generating unit to the filter; and
a potentiometer for measuring an oxidation-reduction potential of the strongly acidic aqueous solution which has passed through the filter.

2. The water treatment system according to claim 1, wherein the filter is a reverse osmosis membrane for filtering raw water to generate permeated water and concentrated water.

3. The water treatment system according to claim 1, further comprising a strongly acidic aqueous solution discharging passage capable of taking out the strongly acidic aqueous solution generated in the strongly acidic aqueous solution generating unit.

4. The water treatment system according to claim 1, further comprising a discharging passage for pouring out a solution generated by mixing the strongly acidic aqueous solution with the permeated water.
